(19) United States
(12) Patent Application Publication
(10) Pub. No.: US 2011/0278831 A1
(43) Pub. Date: Nov. 17, 2011

(54) BINDING BACK AND A METHOD FOR PROTECTING THE BINDING EDGE OF A SHEET BLOCK, AS WELL AS A BINDING FORMED FROM THE SHEET BLOCK AND THE BINDING BACK

(75) Inventors: Iisakki Huotari, Espoo (FI); Henri Huotari, Espoo (FI)

(73) Assignee: Maping Kommandiittiyhtio L. Huotari, Espoo (FI)

(21) Appl. No.: 13/145,908

(22) PCT Filed: Jan. 27, 2010
(86) PCT No.: PCT/IB2010/000637

§ 371 Date: Jul. 22, 2011

(30) Foreign Application Priority Data
Jan. 28, 2009 (EP) 09151578.3

(51) Int. Cl. B42D 1/00; B42C 11/00

(52) U.S. Cl. 281/20; 412/4; 281/21.1

(57) ABSTRACT

The binding edge (61) of a sheet block (31) is protected by a binding back (10) which is fastened to the binding edge (61) of the sheet block (31) in the area and along the length of a non-adhesive strip (12) in the binding back (10) by using fastening devices (33) such as staples, for example, penetrating through the binding back (10) and the sheet block (31). After this, the free end part (21) of the binding back (10) is folded over the non-adhesive strip (12), in which case the remaining edge (23) of the end part (21) extends to the opposite side of the sheet block (31) over the binding edge (61). After this, the adhesive surface (15) is glued to the side of the sheet block (31) that is opposite the non-adhesive strip (12), in which case the backing piece (18) protects the binding edge (61) of the sheet block (31). An independent claim also for a binding back (10) and a binding.

### FIELD OF THE INVENTION

The invention relates to the materials and methods to be used for protecting the binding edge of a sheet block.

### STATE OF THE ART

A sheet block's binding edge can be protected with a binding back. The binding edge is most commonly protected with a binding back having adhesive on one side. The most usual way is to use hot melt glue. In the known binding backs, fastening is carried out most often on a separate device with a heatable plate-like part which melts the adhesive. When it cools, the adhesive tape simultaneously forms the actual binding. In these devices, expensive machine parts are used to position and fold the back so that it fits the binding edge. Another frequent problem with using adhesive is insufficient binding strength, especially when binding paper grades such as coated paper that are difficult to glue.

Alternatively, various kinds of adhesive bands, such as tapes, are used to protect the binding edges of sewn, spine-glued or stapled sheet blocks. Stapling or sewing gives better binding strength than does adhesive binding. Tape is difficult to handle, however, as it sticks to the fingers. Various machine parts have been developed for fastening the tapes, but these cause unnecessary additional costs and work stages. Without auxiliary devices the tape easily becomes skewed, in which case the end result will not be satisfactory.

### PURPOSE OF THE INVENTION

The purpose of the invention is to simplify the protection of the binding edge of a sheet block and thus to provide a relatively simple and quick way of forming a binding from a sheet block without using special covering equipment.

It is possible to achieve this purpose by a binding back and a method in accordance with the independent patent claims.

A binding according to the parallel claim with the binding back is simple and quick to make without using special positioning equipment.

The dependent claims describe inventive aspects and those that are advantageous with respect to the protection of the binding edge of a sheet block.

### ADVANTAGES OF THE INVENTION

A binding back suitable for protecting the binding edge of a sheet block comprises a backing piece, on one side of which is an adhesive surface, in which a strip on the longitudinal edge of the backing piece is left free from adhesive. The adhesive surface comprises adhesive suitable for permanent gluing. In addition, the binding back comprises a removable protective cover on the adhesive surface. Using this kind of binding back, it is possible to protect the binding edge of a sheet block in a simple and quick way. The binding back is intended to be fastened mechanically to the sheet block, whose binding edge is intended to be protected.

The binding back comprises one, two or more grooves crossing the backing piece in the longitudinal direction. The groove or grooves make it possible to obtain an aesthetically better end result for a binding to be formed from a binding back and a sheet block, since the fold takes place along the groove or grooves when folding the binding back, and thus it is possible not only to fold the binding back better, but also, due to the straightness of the fold, to easily make a binding with a more acceptable level of quality.

The binding back's groove or, if the binding back has more than one groove, at least one of the grooves, crosses in the area of the non-adhesive strip or on the edge of the non-adhesive strip bordering with the adhesive surface. This facilitates the folding of the binding back since, if the binding back is folded at the groove or grooves, there is no need to fold two adhesive surfaces against each other. For this reason, it is possible to achieve an end result, i.e. a binding, of better quality, since the chances of making a mistake if two adhesive surfaces are folded against each other are considerable.

The binding back's non-adhesive strip is in the longitudinal direction of the binding back. Thus it is possible to fasten the sheet block's binding edge to the binding back over the whole length.

The adhesive surface is preferably implemented as a sticker and the protective cover as a removable protective paper. This enables the more advantageous manufacture of the binding back, because the technology required to make stickers is known and is easily applicable to the purpose. In addition, the protective paper prevents the adhesive-induced soiling of the equipment used to fasten the sheet block to the binding back. In that case and in order to facilitate use, the edge of the protective cover will preferably have a gripping point which can be turned up and/or extended outside the adhesive surface of the binding back.

According to one advantageous embodiment, the other side of the binding back's backing piece also has an adhesive surface equipped with a protective cover. The adhesive surface is preferably implemented as a sticker and the protective cover as a removable protective paper. This kind of binding back may facilitate and quicken the fastening of the separate cover to the binding.

A binding back, from which the protective cover has been removed and which is fastened in the area and along the length of the non-adhesive strip to a block of sheets fastened to each other by fastening devices such as staples, for example, penetrating through the binding back and the sheet block, provides an excellent way of protecting the sheet block's binding edge when the binding back's free end part has been folded over the non-adhesive strip and the binding edge, and has been glued to the side of the sheet block that is opposite the non-adhesive strip by using the adhesive surface.

The protection of a sheet block's binding edge is easier when the free end part of the binding back is folded over the non-adhesive strip at a groove and/or the free end part is folded onto the binding edge at a groove.

The sheet block's binding edge is protected in the easiest, quickest and most economical way when staples are used as the fastening devices.

The sheet block's binding edge can be protected simply and advantageously by fastening the sheet block's binding edge and a binding back according to the invention in the area and along the length of the binding back's non-adhesive strip by using fastening devices such as staples, for example, penetrating through the binding back and the sheet block. After this, the free end part of the binding back is folded over the non-adhesive strip of the binding back, to the opposite side of the sheet block over the binding edge. Finally, the adhesive surface of the free end part is glued to the side of the sheet block that is opposite the non-adhesive strip and is possibly also glued to the binding edge.

Because the preferably sticker-type adhesive in the binding back covers only a portion of the adhesive tape, and because the binding back is stapled with the adhesive side facing outwards at the same stage as the sheets are bound, it is possible to place the adhesive tape in the right way at the same work stage as the binding is made by stapling.

The soiling of work equipment used in fastening the binding back and the sheet block is prevented, if the protective sheet of the binding back's adhesive surface is removed only after fastening and before gluing.

Folding is facilitated if it is done along the groove in the backing piece preferably a) by folding the outside part of the non-adhesive strip of the backing piece over the strip at the groove and/or b) by folding the free end part of the backing piece over the binding edge at the groove.

An advantageous and simple binding is formed from a sheet block and a binding back. The binding comprises a block of sheets and a binding back according to the invention, from which the protective cover has been removed. The binding edge of the sheets and the binding back are fastened to each other in the area and along the length of the binding back's non-adhesive strip by fastening devices such as staples, for example, penetrating through the binding back and the sheet block. In addition to this, the free end part of the binding back has been folded over the non-adhesive strip so that the adhesive surface has been glued to the side of the sheet block that is opposite the non-adhesive strip of the binding back.

### LIST OF DRAWINGS

The detailed description below describes, by way of example, the structure of a binding back and a binding according to the invention and the method according to the invention in more detail.

The accompanying drawings present:

FIG. 1 a binding back suitable for protecting the back of a sheet block;

FIG. 2 a cross-section of the binding back presented in FIG. 1;

FIG. 3 a sheet block to which the binding back is fastened;

FIG. 4 the folding of the binding back over the binding edge of the sheet block;

FIG. 5 a binding formed from a sheet block and a binding back;

FIG. 6 a cross-section of the binding back presented in FIG. 5; and

FIG. 7 a cross-section of an alternative binding back.

The same reference numbers refer in all drawings to the same or like structural parts.

### DETAILED DESCRIPTION OF THE INVENTION

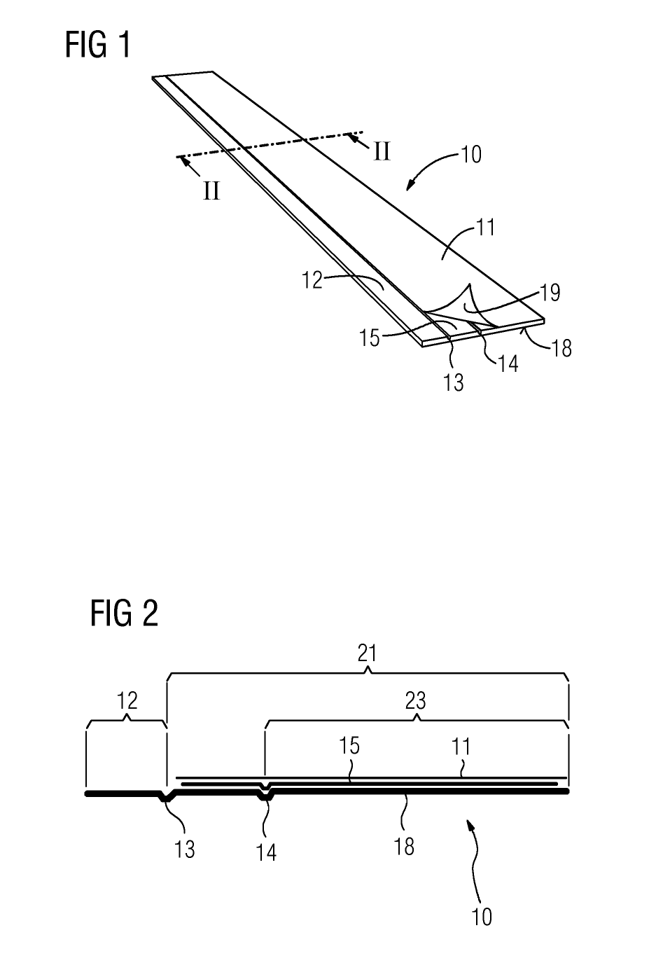

FIGS. 1 and 2 present a binding back 10 which is suitable for protecting the binding edge of a sheet block. The oblong binding back 10 comprises a backing piece 18, on one side of which is an adhesive surface 15, in which a strip 12 on the longitudinal edge of the binding back 18 is left free from adhesive. The adhesive surface 15 comprises adhesive suitable for permanent gluing. The binding back 10 also comprises a removable protective cover 11 on the adhesive surface 15.

The adhesive surface 15 of the binding back 10 is most advantageously implemented as a sticker and the protective cover 11 as a removable protective paper. In that case, the protective cover 11 will have a gripping point 19 which is preferably turned up from the adhesive surface 15 of the binding back 10. The protective cover 11 can also be extended outside the adhesive surface 15.

The binding back 10 comprises a groove 13 which crosses the backing piece 18 in its longitudinal direction and alternatively also another groove 14. The groove 13 crosses in the area of the non-adhesive strip 12. The groove 14 crosses on the edge of the non-adhesive strip 12 bordering with the adhesive surface 15. The grooves 13, 14 are preferably made by a previously known groove-making machine; the groove or grooves 13, 14 can also be implemented as folds.

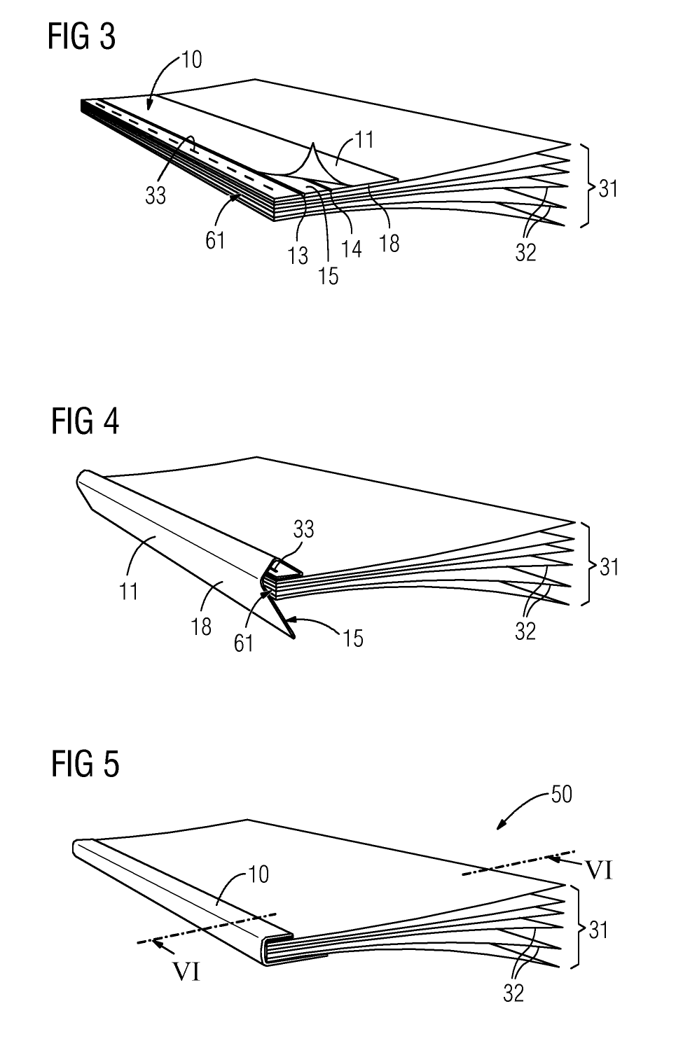

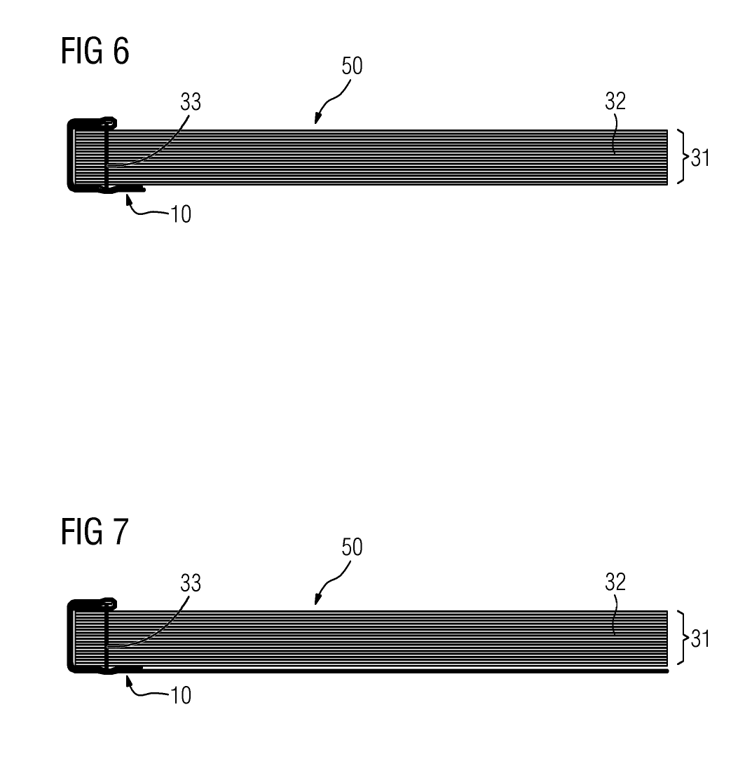

FIGS. 3 to 5 illustrate the method of using the binding back 10. FIG. 3 shows a sheet block 31 which contains individual sheets 32. The binding back 10 is fastened to the binding edge 61 of the sheet block 31 by using staples 33 penetrating through the binding back 10 and the sheet block 31 as shown in FIG. 6 in the area and along the length of the non-adhesive strip 12 in the binding back 10.

After this, when any protective sheet 11 has first been removed, the free end part 21 of the binding back 10 is folded over the non-adhesive strip 12, and the remaining edge 23 of the end part 21 is folded to the opposite side of the sheet block 31 over the binding edge 61, in the way shown in FIG. 4. To facilitate folding over the binding edge 61, the binding back 10 has for this purpose alternatively the groove 14. At the groove 14 it is easier to fold the final part 23 of the free end part over the binding edge 61. Finally, the adhesive surface 15 is glued to the side of the sheet block 31 that is opposite the non-adhesive strip, in the way shown in FIG. 5.

The final result is the binding 50 formed from the sheet block 31 and the binding back 10. In the binding 50, the binding back 10 and the binding edge 61 of the sheet block 31 are fastened to each other in the area and along the length of the non-adhesive strip 12 by the staples 33 penetrating through the binding back 10 and the sheet block 31. The free end part 21 of the binding back 10 is folded towards the non-adhesive strip 12 and is possibly also glued fast to it. The adhesive surface 15 of the remaining edge 23 has been glued to the binding edge 61 and to the side of the sheet block 31 that is opposite the non-adhesive strip 12 of the binding back 10.

Thus the outside part 21 of the non-adhesive strip 12 of the binding back 10 is folded over the non-adhesive strip 12 along the groove 13. The binding back's unattached part 23 is folded along the groove 14 over the binding edge 61. Thus the folding is done along the grooves 13 and 14.

To those skilled in the art it is clear that the detailed description of the invention or the form of words chosen for the claims is not meant to restrict the protective scope demanded for the invention. The invention can also be implemented in ways deviating from the embodiment described in the detailed description, while still remaining within the framework of the protective scope of the claims. For example, instead of staples, other suitable fastening material penetrating through the sheets and the binding back may be used. In addition, the binding back may have more grooves than one or two.

In particular, a third groove can make it easier to fold the binding back 10 at the binding edge 61 to the opposite side of the sheet block 31. Because the distance between the second groove 14 and the third groove depends on the thickness of the sheet block 31, it is possible to offer the binding backs as a product family, with binding backs being provided for different thicknesses of sheet block and in which the distance between the second and third groove is different depending on the thickness of the sheet block to be fastened to the binding back 10.

According to one embodiment of the invention, the other side of the backing piece 18 also has an adhesive surface equipped with a protective cover. The adhesive surface is implemented preferably as a sticker such as the sticker surface 15 and the protective cover as a removable protective paper such as the protective sheet 11.

FIG. 7 presents a certain advantageous embodiment of the invention. In this embodiment, the backing piece 18 of the binding back 10 extends much further than the adhesive surface 15, to the extent that the free end part 21 of the backing piece 18 reaches at least as far as the right-hand edge of the sheets 32 of the sheet block 31, and preferably even further. Thus, the portion of the free end part 21 of the backing piece 10 that extends further than the adhesive surface 15 forms a front or back cover of the binding 50.

The aesthetic impression given by the binding 50 can be improved if the uppermost sheet put on the side opposite to the side covered by the free end part 21 of the binding 50 is a plastic cover leaf which may also be transparent. In particular, polyvinyl chloride (PVC) is an excellent material for the plastic cover leaf.

1. A binding back (10) for protecting the binding edge (61) of a sheet block (31), characterised in that:
the binding back (10) comprises a backing piece (18), on one side of which is an adhesive surface (15), in which a strip (12) on the longitudinal edge of the binding back (18) is left free from adhesive;
the adhesive surface (15) comprises adhesive suitable for permanent gluing; and that
the binding back (10) comprises a removable protective cover (11) on the adhesive surface (15).

2. A binding back (10) according to claim 1, which comprises one, two, three or more grooves (13, 14) crossing the backing piece (18) in the longitudinal direction.

3. A binding back (10) according to claim 2, of whose groove and/or grooves (13, 14), at least one crosses in the area of the non-adhesive strip (12) or on the edge of the non-adhesive strip (12) bordering with the adhesive surface (15).

4. A binding back (10) according to claim 1, whose non-adhesive strip (12) crosses the binding back (10) in the longitudinal direction.

5. A binding back (10) according to claim 1, wherein the adhesive surface (15) is implemented as a sticker and the protective cover (11) as a removable protective paper.

6. A binding back (10) according to claim 1, wherein, at the edge of the protective cover (11), there is a gripping point (19) which is preferably turned up and/or is extended outside the adhesive surface (15) of the binding back (10).

7. A binding back (10) according to claim 1, from which the protective cover (11) has been removed, which binding back (10) is fastened in the area and along the length of the non-adhesive strip (12) to the block (31) of sheets (32) fastened to each other by fastening devices (33) such as staples, for example, penetrating through the binding back (10) and the sheet block (31), in addition to which the free end part (21, 23) of the binding back (10) is folded over the non-adhesive strip (12) and the binding edge (61) and glued to the side of the sheet block (31) that is opposite the strip (12) by using the adhesive surface (15).

8. A binding back (10) according to claim 7, in which the free end part (21) of the binding back (10) is folded over the non-adhesive strip (12) at the groove (13), and/or the remaining edge (23) of the free end part (21) is folded onto the binding edge (61) at the groove (14).

9. A binding back (10) according to claim 1, which comprises a second (14) and third groove, and which is offered as part of a product family comprising several different kinds of binding backs (10), and in which product family, in the binding backs (10) meant for sheet blocks of different thicknesses, the distance between the second (14) and third groove is different, depending on the thickness of the sheet block (31) meant to be fastened at the binding back (10) in question.

10. A binding back (10) according claim 1, in which the other side of the backing piece (18) also has an adhesive surface equipped with a protective cover, which protective cover is implemented preferably as a sticker and which adhesive surface is implemented preferably as a removable protective paper.

11. A method for protecting the binding edge (61) of a sheet block (31), comprises the following acts of:
fastening a binding back (10) according to claim 1 and a binding edge (61) of a sheet block (31) in the area and along the length of a non-adhesive strip (12) in the binding back (10) by using fastening devices (33) such as staples, for example, penetrating through the binding back (10) and the sheet block (31);
folding the free end part (21) of the binding back (10) over the non-adhesive strip (12) so that the remaining part (23) of the free end part comes to the opposite side of the sheet block (31) over the binding edge (61); and
gluing the adhesive surface (15) to the side of the sheet block (31) that is opposite the non-adhesive strip (12) and alternatively also to the binding edge (61).

12. A method according to claim 11, in which the protective sheet (11) of the binding back (10) is removed after fastening and before gluing.

13. A method according to claim 11, in which the folding is done along the groove (13, 14) in the backing piece (10), preferably a) by folding the free end part (21) of the backing piece over the non-adhesive strip (12) at the groove (13) and/or b) by folding the remaining edge (23) of the free end part (21) of the backing piece (10) over the binding edge (61) at the groove (14).

14. A method according to claim 11, in which the fastening is performed by using staples.

15. A binding (50) formed from a sheet block (31) and a binding back (10), which comprises a block (31) of sheets (32) and a binding back (10) according to claim 1 from which the protective cover (11) has been removed, and in which, in the binding (50), the binding back (10) and the binding edge (61) of the sheets (32) are fastened to each other in the area and along the length of the non-adhesive strip (12) by fastening devices (33) such as staples, for example, penetrating through the binding back (10) and the sheet block (31), in addition to which the free end part (21) of the binding back (10) is folded over the non-adhesive strip (12) so that the adhesive surface (15) of the remaining edge (23) is glued to the side of the sheet block (31) that is opposite the non-adhesive strip (12) of the binding back (10).
